(19) United States
(12) Patent Application Publication
(10) Pub. No.: US 2013/0296049 A1
(43) Pub. Date: Nov. 7, 2013

(54) System and Method for Computer Control

(71) Applicant: Thomas Jump, Minneapolis, MN (US)

(72) Inventor: Thomas Jump, Minneapolis, MN (US)

(21) Appl. No.: 13/886,935

(22) Filed: May 3, 2013

Related U.S. Application Data
(60) Provisional application No. 61/642,706, filed on May 4, 2012.

(51) Int. Cl. A63F 13/04

(52) U.S. Cl. CPC A63F 13/04
USPC 463/31

(57) ABSTRACT

A method, computer program product, and system are disclosed. The method including the steps of presenting a virtual representation of an environment, receiving a first input from a first user input device, the first user input device including a motion sensor and a plurality of buttons, receiving a second input from a second user input device, the second user input device including a motion sensor and a plurality of buttons, updating the virtual representation of the environment corresponding to the first input and the second input, wherein the updating generates a modified virtual representation of the environment and presenting the modified virtual representation of the environment.

### CROSS-REFERENCE TO RELATED APPLICATIONS

The present application claims priority to U.S. provisional application 61/642,706 filed on May 4, 2012 entitled System and Method for Computer Control, the contents of which are hereby incorporated by reference herein in their entirety.

### FIELD OF THE INVENTION

The present disclosure relates to systems and methods for controlling a computer. More particularly, the present disclosure relates to devices for use with a computer and methods to control a virtual environment. Still more particularly, the present disclosure relates to a system of computer mice for controlling a computer environment including control of camera direction, character motion, and character actions.

### BACKGROUND

Virtual environments have existed since the inception of the digital age. The first virtual environments generally consisted of text-based representations of an environment. Examples of these types of virtual environments include MUDs (multi-user dungeons), and text-based video games. As computers have become more sophisticated, so too have the virtual environments. For example, instead of providing textual representations of environments, these newer virtual environments may include graphics to represent objects within the environment.

To control various aspects of these representations, typical virtual environments allow a user to control the actions of something with the virtual representation. For example, in some implementations, the user controls an avatar representing an in-game character within the environment that is virtually represented. In such implementations, the user may use a keyboard to control the position of the avatar, the orientation of the camera (e.g., pan up, pan down, pan left, and pan right), and the zoom level of the camera, to name a few examples. In addition, according to particular implementations, the keyboard may be used to execute predefined actions (e.g., the numbers 1-10 corresponding to predefined actions 1-10 on an action bar). Moreover, a mouse or other pointing device can be used to click those actions on the action bar, orient the camera, and change the zoom level of the camera, to name a few examples according to particular implementations.

### SUMMARY

In general, one aspect of the subject matter described in this specification can be embodied in methods that include the actions of presenting a virtual representation of an environment, receiving a first input from a first user input device, the first user input device including a motion sensor and a plurality of buttons, receiving a second input from a second user input device, the second user input device including a motion sensor and a plurality of buttons, updating the virtual representation of the environment corresponding to the first input and the second input, wherein the updating generates a modified virtual representation of the environment and includes moving the position of a camera within the video game environment an amount corresponding to motion-sensor information included in the first input, moving the position of a character within the video game environment an amount corresponding to button-press information included in the first input, and executing an action by the character corresponding to both motion-sensor information and button-press information included in the second input, presenting the modified virtual representation of the environment.

Another aspect of the subject matter described in this specification can be embodied in a computer program product, tangibly encoded on a computer-readable medium, operable to cause a computer processor to perform actions including presenting a virtual representation of the environment, receiving a first input from a first user input device, the first user input device including a motion sensor and a plurality of buttons, receiving a second input from a second user input device, the second user input device including a motion sensor and a plurality of buttons, updating the virtual representation of the environment corresponding to the first input and the second input, wherein the updating generates a modified virtual representation of the environment and includes moving the position of a camera within the virtual representation of the environment an amount corresponding to motion-sensor information included in the first input, moving the position of a character within the virtual representation of the environment an amount corresponding to button-press information included in the first input, and executing an action by the character corresponding to both motion-sensor information and button-press information included in the second input, and presenting the modified virtual representation of the environment.

Another aspect of the subject matter described in this specification can be embodied in a system including a computer processor, a first user input device, the first user input device including a motion sensor and a plurality of buttons, a second user input device, the second user input device including a motion sensor and a plurality of buttons, and computer-readable media with a computer program product tangibly encoded thereon, operable to cause a computer processor to perform operations including, presenting a virtual representation of the environment, receiving a first input from a first user input device, the first user input device including a motion sensor and a plurality of buttons, receiving a second input from a second user input device, the second user input device including a motion sensor and a plurality of buttons, updating the virtual representation of the environment corresponding to the first input and the second input, wherein the updating generates a modified virtual representation of the environment and includes moving the position of a camera within the virtual representation of the environment an amount corresponding to motion-sensor information included in the first input, moving the position of a character within the virtual representation of the environment an amount corresponding to button-press information included in the first input, and executing an action by the character corresponding to both motion-sensor information and button-press information included in the second input, and presenting the modified virtual representation of the environment.

These and other embodiments can each optionally include one or more of the following features. The action can be selected from one of attacking another character in the virtual representation of the environment and blocking an attack from another character in the virtual representation of the environment. Attacking can include utilizing the received motion-sensor information corresponding to one of the four cardinal directions, one of the four ordinal directions, and movement ending in substantially the middle of the virtual representation and the received button-press information corresponding to a first button press. Blocking can include utilizing the received motion-sensor information corresponding to one of the four cardinal directions, one of the four ordinal directions, and the absence of motion and the received button-press information corresponding to a second button press. The first user input device can include an optical-motion sensor. The second user input device can include an optical-motion sensor. The first user input device can include four buttons, the buttons corresponding to moving the character forward, backward, left, and right within the game environment. The second user input device can include two buttons, the buttons corresponding to an attach action and a block action within the game environment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a system for computer control, according to some embodiments.

FIG. 2A shows a top view of an input device of the system of FIG. 1, according to one embodiment.

FIG. 2B shows a perspective view of an input device of the system of FIG. 1, according to one embodiment.

FIG. 2C shows a front view of an input device of the system of FIG. 1, according to one embodiment.

FIG. 2D shows a side view of an input device of the system of FIG. 1, according to one embodiment.

FIG. 3 shows a virtual representation of an environment and corresponding degrees of motion available to a user of the system of FIG. 1, according to some embodiments.

FIG. 4 shows a flowchart of operations, performable by the system of FIG. 1, for modifying a virtual representation of an environment, according to some embodiments.

FIG. 5 shows an input device for use with the system of FIG. 1, according to some embodiments.

Like reference numbers and designations in the various drawings indicate like elements.

### DETAILED DESCRIPTION

The present disclosure, in some embodiments, relates to a computer system particularly adapted to provide advanced motion, viewing, and action control in a virtual environment. That is, in some embodiments, multiple mice may be provided each having a motion sensor and a plurality of buttons. In some uses of the system, for example in the context of a virtual world type game, one of the motion sensors on one of the mice may be used to control the camera direction or viewing direction of a user's character and the buttons on the mouse may be used to control the motion of the character, for example. As such, the additional mouse may be freed up, when compared to more conventional systems, to allow for a wider range of activities with multiple degrees of freedom/motion. As such, while historically, characters in these types of games were required to look in the direction the character was moving or pointing, the present system allows for a character to look in directions that differ from the direction the character is moving or the direction the character's body is pointed. Still further, the additional degrees of freedom provided by the additional mouse may allow for more calculated refined interaction between characters such as in combat games involving attacking and blocking, for example. These refined interactions allow for the skill level of the player to be better represented when two player-controlled characters engage each other within the video game environment.

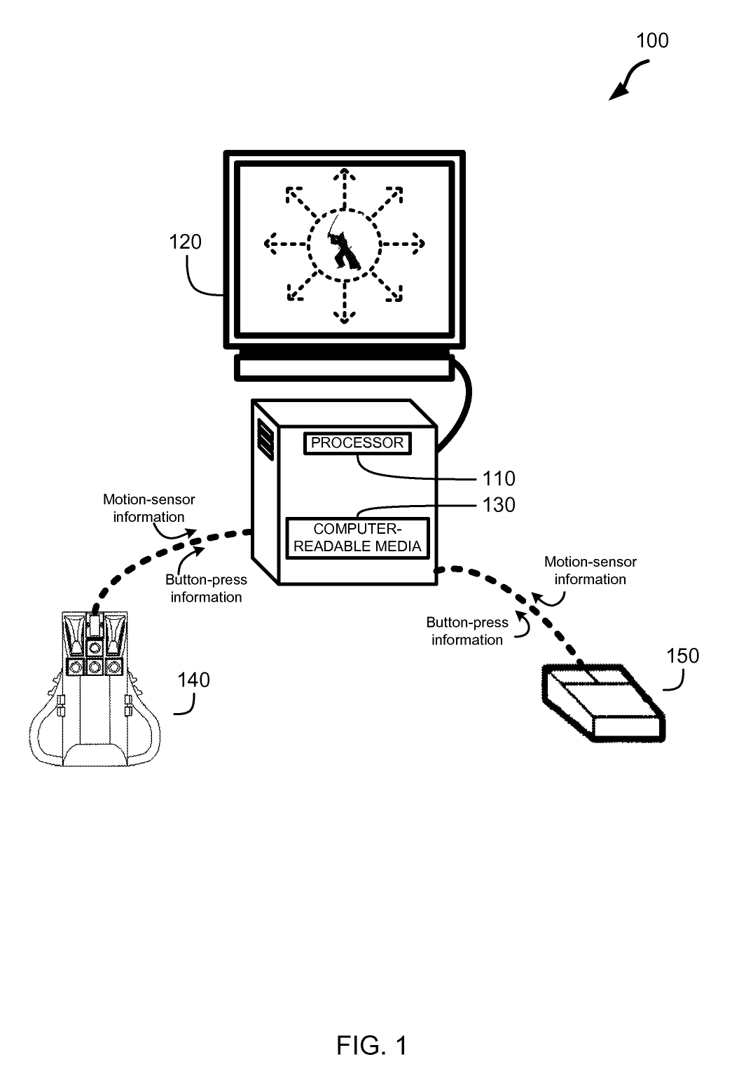

FIG. 1 shows an example system 100. The system 100 includes a processor 110, a display device 120, computer-readable storage media 130, a first input device 140, and a second input device 150. The system 100 may be used to present a virtual representation of an environment. For example, the system 100 can present a virtual representation corresponding to a video game program product that is tangibly embodied on the computer-readable media 130. In other implementations, the system 100 can present a virtual representation corresponding to a real-world physical environment, such as a room in a house or an outdoor space. As such, the virtual representation can be purely virtual (e.g., rendering a scene based on three-dimensional computer-generated geometry stored on the computer-readable media 130), it can be a virtual representation of an actual physical area (e.g., presenting streaming video or one or more images captured by an image capture device, such as a video camera), or it can be a form of altered reality (e.g., rendering objects based on three-dimensional computer-generated geometry stored on the computer-readable media 130 as an overlay on top of streaming video or one or more images captured by an image capture device, such as a video camera).

The first input device 140 and the second input device 150 may be used to allow a user of the system 100 to manipulate aspects of both the virtual representation and the environment which is presented, according to particular implementations. In some implementations, the first user input device 140 may be used to manipulate the position of the camera within the environment. For example, the first user input device 140 may include a motion-sensor that can capture movement exerted by the user on the first user input device 140 which can be received as motion-sensor information by the processor 110 that may be executing a program product (e.g., a video game) tangibly embodied on the computer-readable storage media 130.

Once received, the computer processor 110 can process this communication and perform a number of operations causing the camera within the program product to change orientation (e.g., pan to the left, pan to the right, pan up, pan down, and combinations of these) within the virtual representation corresponding to the received motion-sensor information. As such, moving the first user input device 140 may cause the portion of the environment presented as the virtual representation to change, allowing the user of the system 100 to view other aspects of the environment. That is, moving the first user input device 140 may cause the system 100 to create a modified virtual representation and present the modified representation to the user where the before and after representations include differing views of the virtual environment.

In addition, the first user input device 140 may also be used to manipulate the position of an avatar (e.g., a character) corresponding to the position of the user within the environment. For example, the first user input device 140 may include a plurality of buttons. In some implementations, these buttons may be configured to correspond to forward, back, left, and right movements of the avatar within the environment. As such, if the user presses one of these buttons, button-press information is received by the processor executing the program product. The computer processor may process this communication and perform a number of operations to cause the avatar to move within the environment corresponding to button-press information provided by the first user input device 140 and may cause the portion of the environment presented as the virtual representation to change. That is, pressing buttons included on the first user input device 140 may cause the system 100 to create a modified virtual representation and present the modified representation to the user, where the before and after representations include differing positions of the character in the virtual environment.

The second user input device 150 can be used to cause the avatar within the environment to perform an action. For example, the second user input device 150 may include a motion-sensor that can capture movement exerted by the user on the second user input device 150 which can be received as motion-sensor information by the processor 110 executing a program product (e.g., a video game) tangibly embodied on the computer-readable storage media 130. Similarly the second user input device 150 may include a plurality of buttons that can be pressed which can be received by the program product as button-press information. The computer processor 110 may use both the motion-sensor information and the button-press information to cause the avatar to perform an action according to the received information. For example, once received, the processor 110 can process this communication and perform a number of operations causing the avatar to perform the desired action. In general, different combinations of motions and button presses may operate to cause the avatar to perform different actions within the environment.

For example, in one implementation, consider two players: A and B whom are facing each other in a video game environment. If player A moves their respective second user input device 150 in a generally up and left direction while pressing a first button on their respective second user input device 150 this combination of actions (i.e., moving the second user input device 150 and pressing the first button on the second user input device) may cause an avatar in a Japanese-style sword fighting game to perform an attack against player B's avatar within the environment. In the provided example, the sword of player A's avatar traces a substantially similar path in performing the attack (i.e., up and left) from player A's perspective, but would correspond to an attack moving up and to the right from player B's perspective. That is, in some implementations, player A's movements are mirrored when viewed by player B and vice versa. To illustrate another interaction within the virtual representation, according to a particular embodiment, if player A performs an attack against player B by moving their respective second user input device 150 in a generally down and to the right direction while pressing the first button, player B may block the attack by moving their respective second user input device 150 to the upper left and pressing the second button on their respective second user input device 150.

Likewise, if the virtual representation depicts an actual physical area, the first input device 140 can be used to manipulate the position of the camera within the environment, the position of an avatar corresponding to the position of the user within the environment, and the user input device 150 can be used to cause the avatar within the environment to perform an action.

In some implementations, the processor 110 may be a programmable processor including processors manufactured by INTEL (of Santa Clara, Calif.) or AMD (of Sunnyvale, Calif.). Other processors may also be provided. The processor 110 may be configured to perform various operations, including but not limited to input-output (I/O) operations, display operations, mathematical operations, and other computer logic based operations. The processor may be in data communication with each of the input devices 140, 150 and may also be in data communication with each of the computer-readable storage media 130 and the display device 120.

In some implementations, the display device may be cathode ray tube (CRT) device, a liquid crystal display (LCD) device, a plasma display device, or a touch-sensitive display device. Still other display devices may be provided. In some embodiments, the display device may be a common computer monitor or it may be a more portable device such as a laptop screen or a handheld device. Still other types of display devices may be provided.

In some implementations, the computer-readable storage media 130 may include optical media, such as compact disks (CDs), digital video disks (DVDs), or other optical media. In other implementations, the computer-readable storage media 130 may be a magnetic drive, such as a magnetic hard disk. In still other implementations, the computer-readable storage media 130 may be a solid-state drive, such as a flash drive, read-only memory (ROM), or random access memory (RAM). Still other types of computer-readable storage media may be provided. In some implementations, the first user input device 140 may include an optical motion sensor, such as a light emitting diode (LED) received by a complementary metal-dioxide sensor (CMOS) to determine changes in position based on differences in the images captured by the CMOS. In other implementations, the first user device 140 may include a physical sensor such as a trackball (on top or on bottom of the first user input device 140) that translates the physical motion of the trackball into a change of position of the mouse. Still other motion sensing systems or devices may be provided. In addition, the first user input device 140 may be in wired or wireless communication with the processor, according to particular implementations.

In some implementations, the second user input device 150 may include an optical motion sensor, such as a light emitting diode (LED) received by a complementary metal-dioxide sensor (CMOS) to determine changes in position based on differences in the images captured by the CMOS. In other implementations, the second user device 150 may include a physical sensor such as a trackball (on top or on bottom of the second user input device 150) that translates the physical motion of the trackball into a change of position of the mouse. Still other motion sensing systems or devices may be provided. In addition, the second user input device 150 can be in wired or wireless communication with the processor, according to particular implementations.

In some implementations, the system 100 may also include a network card. The network card may allow the system 100 to access a network (e.g., a local area network (LAN), or a wide area network (WAN)) and communicate with other systems that include a program product substantially similar to ones described herein. For example, a plurality of systems 100 can include computer-readable storage media 130 that have video game program products encoded thereon. These video game program products can communicate with each other vis-à-vis their respective network cards and the network to which they are apart to allow one user of the system 100 to play the video game program product in either cooperative or competitive modes interactively with the other users having access to their own systems 100. In still other implementations, an Internet or other network-based system may be provided where the program product is stored on computer-readable storage media of a remote computer accessible via a network interface such as a web page, for example. In this context, one or more users may access the program product via the web page and may interact with the program product alone or together with others that similarly access the program product. Still other arrangements of systems and interactions between users may be provided.

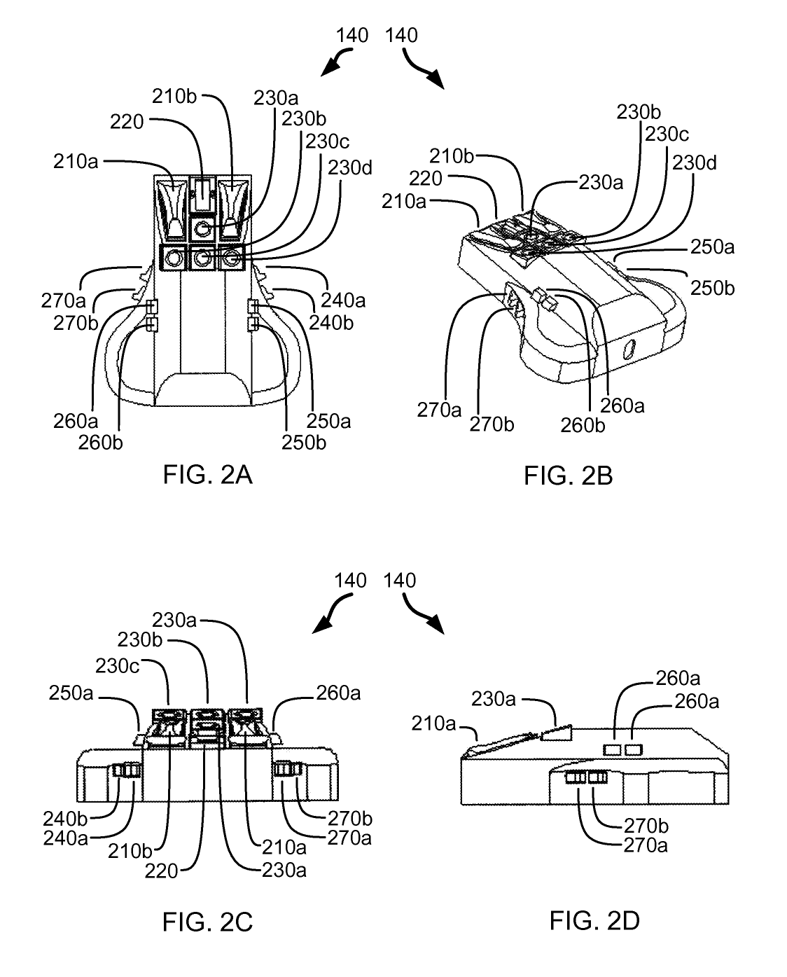

FIGS. 2A-2D show four views of an example first input device 140. The first input device 140 may include device buttons 210a-210b, a scroll wheel 220, four top buttons 230a-230d, a pair of right-wing buttons 240a-240b, a pair of right-body buttons 250a-250b, a pair of left-body buttons 260a-260b, and a pair of left-wing buttons 270a-270b.

The two device buttons 210a-210b may operate similar to left and right mouse buttons, respectively, in a comparable two-button mouse. In an example, the left mouse button 210a may act as a left mouse button in a two-button mouse: a single-click may cause the object under the cursor to become active, and two clicks in quick succession may cause the object under the cursor to execute an operation. In an example, the right device button 210b may act as a right mouse button in a two-button mouse: a single-click may cause a menu to display on the screen or perform some other operation. In some implementations, pressing both left and right device buttons 210a and 210b, respectively, may act as a third mouse button. In other implementations, device buttons' 210a-210b functionality may be set by the operating system of the computer, may be set by the application in use, or may be user-configurable, to name a few examples. In some embodiments, for example, the device buttons 210a-210b may be configured opposite a comparable two-button mouse such that when used with a left hand as would be the case in FIG. 1, the buttons functions correspond to the fingers a user would use to actuate them. As such, the left mouse button on the input device 140, which may be depressed by the forefinger of the user's left hand may function similar to the right mouse button on the input device 150, which may be depressed by the forefinger of the user's right hand. Still other functional configurations may be provided.

The scroll wheel 220 may be used to cause the display to move a direction indicated by the spinning or tilting of the wheel. In an example, spinning the scroll wheel may cause the display to move up or down. In another example, the scroll wheel may be tilted to the right or left, and the wheel may be spun up or down. In yet another example, the scroll wheel may operate as a third mouse button.

The four top buttons 230a-230d may be be programmed to perform various functions. For example, in some implementations, the programmable buttons 230a-230d can be programmed to operate similar to the arrow keys on a QWERTY keyboard. In some embodiments, as shown in FIG. 2A, the buttons 230a-230d may be arranged in an inverted T-shape similar to an arrow key arrangement on a keyboard. The functionality of the buttons 230a-230d may be set by the operating system of the computer, the application in use, or by the user, to name a few examples.

In addition, the pair of right-wing buttons 240a-240b, the pair of right-body buttons 250a-250b, the pair of left-body buttons 260a-260b, and the pair of left-wing buttons 270a-270b operate as additional conventional keyboard keys. In some implementations, these buttons may be configured to mirror functionality of specific keys on a keyboard. For example, any of buttons 240a-240b, 250a-250b, 260a-260b, and 270a-270b may be configured to mirror the functionality of the right shift key on a keyboard. Thus when a user presses the configured button it is as if the user used a keyboard to press the right shift key on the keyboard. The buttons 240a-240b, 250a-250b, 260a-260b, and 270a-270b may be configured by the user, by a particular computer application, or may be predefined by ROM included in the second user input device 150, to name a few examples. Also, in some implementations, the buttons 240a-240b, 250a-250b, 260a-260b, and 270a-270b may be used to begin execution of a predetermined sequence of keystrokes or mouse button clicks, as if they were being performed on a keyboard or mouse, respectively (i.e., the buttons 240a-240b, 250a-250b, 260a-260b, and 270a-270b can perform a macro). For example, any of the buttons 240a-240b, 250a-250b, 260a-260b, and 270a-270b may be configured to execute an input corresponding to the keystrokes “/taunt” to execute a taunting type animation against the target. Accordingly, the first user input device 140 may act as a traditional mouse or a combination of a keyboard and mouse.

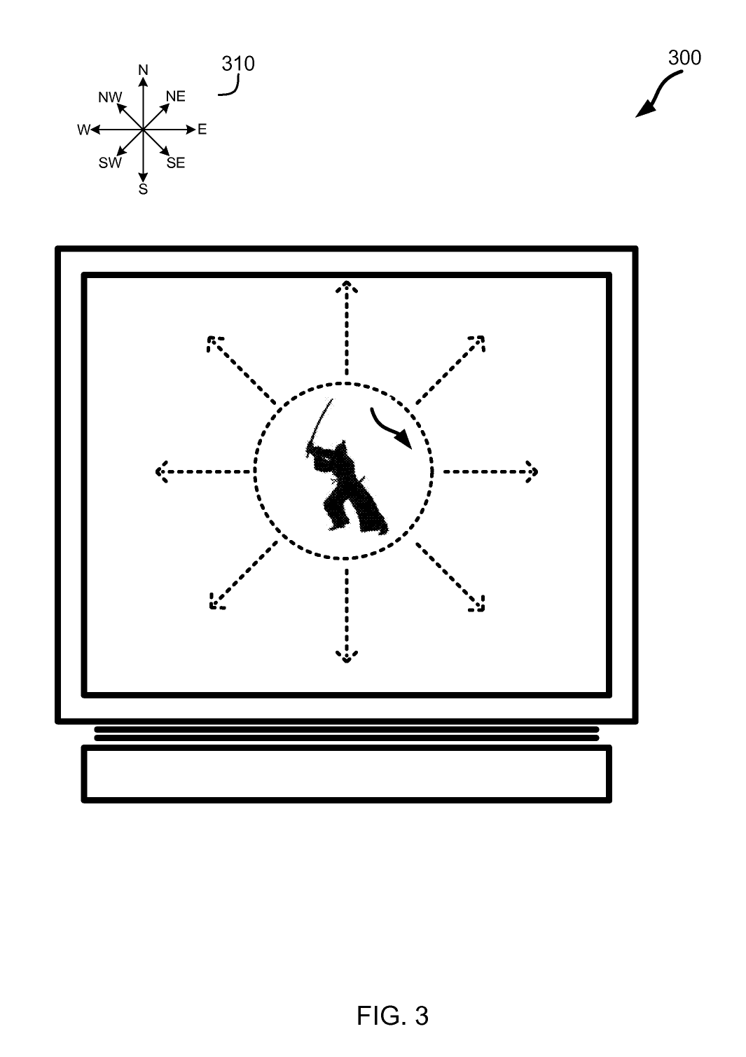

FIG. 3 shows an example implementation of a combat system for a virtual representation 300 of an environment. Here, the environment is a video game, although it should be understood that manipulations described herein of the first user input device 140 and the second user input device 150 can be used to achieve other actions for video games or other actions for different environments, such as in non-virtual spaces (e.g., as a way to control a robot in a hazardous environment) or different actions in virtual spaces (e.g., a robotic war game environment, a three-dimensional space environment, a first person shooter environment, or other game environments according to different implementations). In the particular illustration, the virtual representation 300 is presented from a first-person perspective. That is, the camera is oriented such that the virtual representation 300 is presented through the eyes of the particular user. For example, the warrior figure 315 is that of another in-game avatar and not the user of the system 100 viewing the virtual representation 300. In other implementations, the warrior figure 315 may be the in-game avatar of the user of system 100 viewing the virtual representation 300. For example, over-the-shoulder camera positions, isometric camera positions, and top-down camera positions may also be used to alter the vantage point by which the virtual representation is presented.

The virtual representation 300 depicted is a samurai-style video game environment. That is, the player takes on the role of a samurai and engages other samurai warriors. The other samurai warriors can be either computer-controlled or human-controlled samurai warriors. For example, the virtual representation 300 can be configured to access a network (e.g., a LAN or a WAN) to communicate with other systems 100 to provide interactive game-play between one or more human players.

As described above, the first user input device 140 can be used to manipulate both the camera position of a camera within the virtual represent 300 of an environment and the position of the user's avatar samurai warrior within the virtual representation 300 of an environment. Additionally, the second user input device 150 can be used to perform a plurality of actions. In the illustrative virtual representation 300 of a samurai-style video game environment, the user can select between attack actions and block actions. In some implementations, an icon such as a cursor icon (not shown) is presented within the virtual representation 300 showing the relative position of the second user input device 150 as it relates to the virtual representation 300.

The following example involves two players: A and B. In the provided example, players A and B are facing each other, although it should be understood that depending on the relative position between players A and B, the attack actions and corresponding blocking actions may be different. For example, if player A is partially flanking player B, player B would perform a different movement using their respective second user input device 150 to block an attack, where the attack is being initiated by player A using a substantially similar motion (to that of the motion made when the players are facing each other) of player A's second user input device 150.

To perform an attack, player A can move their respective second user input device 150 in a cardinal direction (where the cardinal directions of N, S, E, and W are represented by the compass rose 310), or an ordinal direction (again where the ordinal directions of NE, SE, NW, and SW are in reference to the compass rose 310) to perform various slashes, chops, and thrusts. For example, if the player A moves the second input device 150 from the center of the screen (represented by the dashed circle surrounding the warrior figure 315) to the northeastern portion of the screen and presses a first button on the second input device 150, the attack performed is an upward right-side slash (from the perspective of player A), and an upward left-side slash from the perspective of player B. As another example, if the user does not move the second user input device 150 and presses the first button on the second input device 150, the attack performed is a thrust (i.e., a straight ahead arm motion for example).

In addition to performing attacks, the user can manipulate the second user input device 150 to perform a blocking action. For example, consider the attack described above where player A performs an upward right-hand slash by moving the mouse in a generally northeastern direction. This would cause the user's avatar to execute an attack starting toward the bottom left (in relation to player A's in-game avatar), and moving toward the upper right. Player B, however, would witness an attack being made starting at the bottom right of their virtual representation 300 and moving toward the upper left of their virtual representation. In response, player B can move their respective second user input device 150 such that the cursor representing the relative location of the second user input device 150 is in the southeastern (i.e., bottom right) portion of the virtual representation 300 and press a second button on the second user input device 150 to block the incoming attack. That is, moving the second user input device to the southeastern portion of the virtual representation 300 is effective at blocking attacks made by player A who moved their respective second user input device 150 in a generally northeastern direction. Similarly, if player A moves the cursor into substantially the middle portion of their respective virtual representation 300 and presses the first button of their respective second user input device to perform a thrust attack, player B can counter the thrust by moving and their respective second user input device 150 into substantially the middle portion of their respective virtual representation 300 and pressing the second button of their respective second user input device 150 to block player A's thrust.

In this manner, the video game program product described may have a high degree of skill that appeals to more accomplished video game players (e.g., those that play video games competitively and those that may spend a number of hours daily playing video games). Users may both manipulate the camera and the position of the character within the virtual environment 300 using the first user input device 140, but users may also perform attacks using nine-degrees of motion (the four ordinal and the four cardinal directions, and placing the cursor in substantially the middle portion of the virtual environment 300) and quickly react to attacks directed at the user by executing the corresponding block that can effectively block the attack aimed at the user's in-game avatar (examples of which have been described above).

That is, instead of haphazardly using input devices to perform in-game actions, users achieve in-game success using controlled movements that can be countered by specific other similarly controlled movements. So instead of allowing the position of the character and camera orientation dictate the attack or block to be performed, player A's attacks and blocks can be performed irrespective of the position of the in-game avatar or the orientation of the camera within the environment being virtual represented. Likewise, player B can perform attack and block actions independently of the position their in-game avatar and the orientation of the camera within the environment being virtually represented. This increases the skill-level required because players utilizing the control scheme described herein are generally responsible for how the actions are to be performed as well as the character position, and the camera orientation. Contrast this with traditional control schemes where users are responsible only for the position of the character and the orientation of the camera with the environment presented by the virtual representation 300.

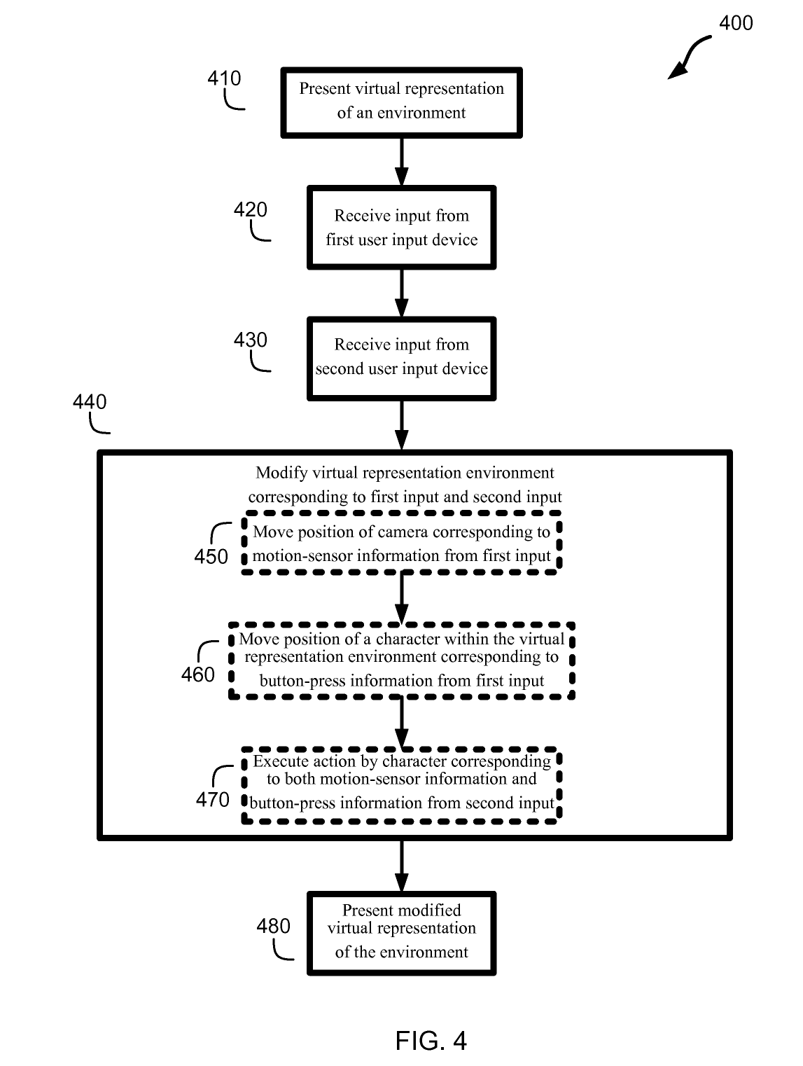

FIG. 4 is a flow chart illustrating an example method 400. For illustrative purposes, the method 400 is described as being performed by system 100, although it should be understood that other systems can be configured to execute method 400. Also, for convenience FIG. 4 is described in reference to a video game program product, but can be performed with implementation other program products that provide virtual representations of environments. In operation 410, the system 100 may present a virtual representation of an environment. For example, in reference to FIGS. 1 and 3, the system 100 may present virtual representation 300 on display device 120.

In operation 420, the system 100 may receive input from a first user input device. For example, in reference to FIGS. 1 and 2, the system 100 can receive motion-sensor input from the first user input device 140 corresponding to movement of the first user input device 140 by the user. Also, in reference to FIGS. 1 and 2, the system 100 can also receive button-press information corresponding to the user pressing any of the buttons 210a-210b, 220, 230a-230d, 240a-240b, 250a-250b, 260a-260b, 270a-270b alone or in combination, to name another example.

In operation 430, the system 100 may receive input from a second user input device. For example, in reference to FIG. 1, the system 100 can receive both motion-sensor information and button-press information from the second user input device 150. In some implementations, the motion-sensor information may correspond to movement of the second user input device 150 by the user and the button-press information may correspond to pressing a first button or a second button on the second user input device 150.

In operation 440, the system 100 may modify the virtual representation of the environment corresponding to the first input and the second input. For example, the system 100 can perform one or more of operations 450-470 (described in more detail below) to generate a modified representation of the video game environment 300 corresponding to some combination of camera movements, character movements, and character actions corresponding to information received by the system 100 from the first user input device 140 and second user input device 150.

In operation 450, the system 100 may move a position of a camera corresponding to motion-sensor information from the first input. For example, an in-game camera can pan to the left, pan to the right, pan up, pan down, and combinations of these within the virtual representation an amount corresponding to the received motion-sensor information. As such, in some implementations, panning the camera a particular amount corresponding to received motion-sensor information from the first input device 140 modifies the virtual representation in that a different portion of the environment is presented and virtually represented because the position of the in-game camera presents a different perspective of the environment.

In operation 460, the system 100 may move a position of a character within the virtual representation corresponding to button-press information from the first input. For example, in reference to FIGS. 1-3, the user's in-game avatar can be moved by a user pressing the buttons 230a-230d on the first user input device 140 corresponding to forward, right, back, and left movements respectively and causing button-press information to be received by the system 100. In response, the system 100 performs operations causing the character's avatar to move within the virtual representation 300. As such, in some implementations, moving the user's in-game avatar corresponding to received button-press information from the first input device 140 modifies the virtual representation in that a different portion of the environment is presented and virtually represented because the position of the user's in-game avatar changes.

In operation 470, the system 100 executes an action by a character corresponding to both motion-sensor information and button-press information from the second input. For example, in reference to FIGS. 1-3, the user of the system 100 can perform an attack against the samurai warrior 315 by a combination of moving the second user input device 150 and pressing a first button on the second user input device, causing motion-sensor information and button-press information to be received by the system 100. In response, the system 100 performs an attack corresponding to the combined motion-sensor information and button-press information. For example moving the second user input device 150 into substantially the center of the virtual representation 300 and pressing a left mouse button on the second user input device 150 causes the user's in-game avatar to perform a thrust attack.

As another example, the user of the system 100 can block an attack from the samurai warrior 315 by a combination of moving the second user input device 150 and pressing a second button on the second user input device, causing motion-sensor information and button-press information to be received by the system 100. In response, the system 100 performs a block corresponding to the combined motion-sensor information and button-press information. For example moving the second user input device 150 into substantially the center of the virtual representation 300 and pressing a right mouse button on the second user input device 150 causes the user's in-game avatar to perform a block effective at blocking the samurai warrior's 315 thrust attack.

In some implementations, performing an action by the user's in-game avatar modifies the virtual representation in that the actions can cause a change to the virtually represented environment. For example, if an attack action is successful, the target of the attack may be harmed in some way that is virtually represented (e.g., the samurai warrior 315 may be killed and removed from the virtual representation 300 of the video game environment). Likewise, the virtual representation 300 changes to present that the action. For example, the virtual representation 300 may change to represent a combination of a sword swing corresponding to an attack action performed by the samurai warrior 315 and a sword swing corresponding to a block action performed by the user of system 100.

In operation 480, the system 100 presents a modified virtual representation of the environment. For example, the system 100 can present a modified virtual representation corresponding to one or more of operations 450-470 on the display device 120.

It will be appreciated that while the operations 410-480 are shown in a flow chart and have been described in order, some or all of the operations may be performed in other orders or may be omitted. Still further, while the configuration of the input devices 140 and 150 has been described such that the input device 140 provides camera control and motion control and the input device 150 provides action control, other configurations of the input devices may be provided and adapted for the particular environment being navigated or viewed. Suitable configurations may be selected to optimize the availability of the several analog and digital input options.

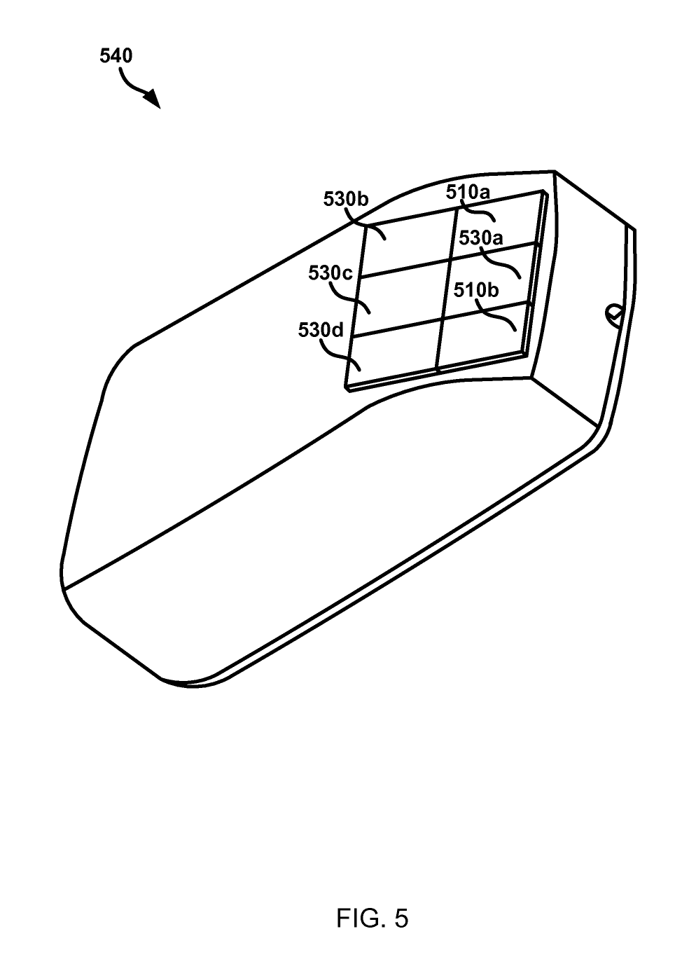

FIG. 5 shows an input device 540 for use with the system of FIG. 1. The input device 540 may be similar to the device 140 in some respects and different than device 140 in other respects. The device 540 may include device buttons 510a-510b, and four top buttons 530a-530d.

The two device buttons 510a-510b may operate similar to left and right mouse buttons, respectively, in a comparable two-button mouse. In an example, the left mouse button 510a may act as a left mouse button in a two-button mouse: a single-click may cause the object under the cursor to become active, and two clicks in quick succession may cause the object under the cursor to execute an operation. In an example, the right device button 510b may act as a right mouse button in a two-button mouse: a single-click may cause a menu to display on the screen or perform some other operation. In some implementations, pressing both left and right device buttons 510a and 510b, respectively, may act as a third mouse button. In other implementations, device buttons' 510a-510b functionality may be set by the operating system of the computer, may be set by the application in use, or may be user-configurable, to name a few examples. In some embodiments, for example, the device buttons 510a-510b may be configured opposite a comparable two-button mouse such that when used with a left hand as would be the case in FIG. 1, the buttons functions correspond to the fingers a user would use to actuate them. As such, the left mouse button on the input device 540, which may be depressed by the forefinger of the user's left hand may function similar to the right mouse button on the input device 150, which may be depressed by the forefinger of the user's right hand. Still other functional configurations may be provided.

The four top buttons 530a-530d may be programmed to perform various functions. For example, in some implementations, the programmable buttons 530a-530d can be programmed to operate similar to the arrow keys on a QWERTY keyboard. In some embodiments, as shown in FIG. 5, the buttons 530a-530d may be arranged in an inverted T-shape similar to an arrow key arrangement on a keyboard. The functionality of the buttons 530a-530d may be set by the operating system of the computer, the application in use, or by the user, to name a few examples.

In comparison to FIG. 2, notably missing from the particular embodiment depicted in FIG. 5 is a scroll wheel 220, a pair of right-wing buttons 240a-240b, a pair of right-body buttons 250a-250b, a pair of left-body buttons 260a-260b, and a pair of left-wing buttons 270a-270b. While this particular embodiment does not include these features, it will be appreciated that some or all of these features may be selectively included in a manner similar to that show with respect to the device 140. As such, a large range of solutions may be provided and designed by selectively including some portion or all of the identified buttons and associated functionality.

It is to be appreciated that the present input device 540 may be used with the system in lieu of input device 140 and device 540 may perform many of the same functions of device 140 described above with respect to FIGS. 1-4. In still other embodiments, a combination of devices 140 and 540 may be used. A suitable input device 140 and/or 540 may be selected for use based on the scenario, game, or computer software that is being implemented on the system.

Thus, particular embodiments of the subject matter have been described. Other embodiments are with the scope of the following claims.

What is claimed:

1. A method comprising:
presenting a virtual representation of an environment;
receiving a first input from a first user input device, the first user input device including a motion sensor and a plurality of buttons;
receiving a second input from a second user input device, the second user input device including a motion sensor and a plurality of buttons;
updating the virtual representation of the environment corresponding to the first input and the second input, wherein the updating generates a modified virtual representation of the environment and includes moving the position of a camera within the video game environment an amount corresponding to motion-sensor information included in the first input, moving the position of a character within the video game environment an amount corresponding to button-press information included in the first input, and executing an action by the character corresponding to both motion-sensor information and button-press information included in the second input; and
presenting the modified virtual representation of the environment.

2. The method of claim 1, wherein the action is selected from one of attacking another character in the virtual representation of the environment and blocking an attack from another character in the virtual representation of the environment.

3. The method of claim 2, wherein attacking includes utilizing the received motion-sensor information corresponding to one of the four cardinal directions, one of the four ordinal directions, and movement ending in substantially the middle of the virtual representation and the received button-press information corresponding to a first button press.

4. The method of claim 2, wherein blocking includes utilizing the received motion-sensor information corresponding to one of the four cardinal directions, one of the four ordinal directions, and the absence of motion and the received button-press information corresponding to a second button press.

5. A computer program product, tangibly encoded on a computer-readable medium, operable to cause a computer processor to perform operations comprising:
presenting a virtual representation of the environment;
receiving a first input from a first user input device, the first user input device including a motion sensor and a plurality of buttons;
receiving a second input from a second user input device, the second user input device including a motion sensor and a plurality of buttons;
updating the virtual representation of the environment corresponding to the first input and the second input, wherein the updating generates a modified virtual representation of the environment and includes moving the position of a camera within the virtual representation of the environment an amount corresponding to motion-sensor information included in the first input, moving the position of a character within the virtual representation of the environment an amount corresponding to button-press information included in the first input, and executing an action by the character corresponding to both motion-sensor information and button-press information included in the second input; and
presenting the modified virtual representation of the environment.

6. The computer program product of claim 5, wherein performing the action further causes the computer processor to perform an operation selected from attacking another character in the virtual representation of the environment and blocking an attack from another character in the virtual representation of the environment.

7. The computer program product of claim 6, wherein the attacking operation includes utilizing the received motion-sensor information corresponding to one of the four cardinal directions, one of the four ordinal directions, and movement ending in substantially the middle of the virtual representation and the received button-press information corresponding to a first button press.

8. The computer program product of claim 6, wherein the blocking operation includes utilizing the received motion-sensor information corresponding to one of the four cardinal directions, one of the four ordinal directions, and the absence of motion and the received button-press information corresponding to a second button press.

9. A system comprising:
a computer processor;
a first user input device, the first user input device including a motion sensor and a plurality of buttons;
a second user input device, the second user input device including a motion sensor and a plurality of buttons; and
computer-readable media with a computer program product tangibly encoded thereon,
operable to cause a computer processor to perform operations comprising:
presenting a virtual representation of the environment;
receiving a first input from a first user input device, the first user input device including a motion sensor and a plurality of buttons;
receiving a second input from a second user input device, the second user input device including a motion sensor and a plurality of buttons;
updating the virtual representation of the environment corresponding to the first input and the second input, wherein the updating generates a modified virtual representation of the environment and includes moving the position of a camera within the virtual representation of the environment an amount corresponding to motion-sensor information included in the first input, moving the position of a character within the virtual representation of the environment an amount corresponding to button-press information included in the first input, and executing an action by the character corresponding to both motion-sensor information and button-press information included in the second input; and
presenting the modified virtual representation of the environment.

10. The system of claim 9, wherein performing the action further causes the computer processor to perform an operation selected from attacking another character in the virtual representation of the environment and blocking an attack from another character in the virtual representation of the environment.

11. The system of claim 10, wherein the attacking operation includes utilizing the received motion-sensor information corresponding to one of the four cardinal directions, one of the four ordinal directions, and movement ending in substantially the middle of the virtual representation and the received button-press information corresponding to a first button press.

12. The system of claim 10, wherein the blocking operation includes utilizing the received motion-sensor information corresponding to one of the four cardinal directions, one of the four ordinal directions, and the absence of motion and the received button-press information corresponding to a second button press.

13. The system of claim 9, wherein the first user input device includes an optical-motion sensor.

14. The system of claim 9, wherein the second user input device includes an optical-motion sensor.

15. The system of claim 9, wherein the first user input device includes four buttons, the buttons corresponding to moving the character forward, backward, left, and right within the game environment.

16. The system of claim 9, wherein the second user input device includes two buttons, the buttons corresponding to an attach action and a block action within the game environment.
